(19) United States
(12) Patent Application Publication
(10) Pub. No.: US 2025/0109728 A1
(43) Pub. Date: Apr. 3, 2025

(54) VALVE ASSEMBLY WITH HARD SURFACE TREATMENT

(71) Applicant: CLEAN AIR POWER GT LIMITED, Melton Mowbray, Leicestershire (GB)

(72) Inventors: Dan SKELTON, Melton Mowbray, Leicestershire (GB); Ed NEWMAN, Melton Mowbray, Leicestershire (GB); Neil SULLY, Melton Mowbray, Leicestershire (GB)

(21) Appl. No.: 18/833,117

(22) PCT Filed: Jan. 26, 2023
(86) PCT No.: PCT/GB2023/050165

§ 371 Date: Jul. 25, 2024

(30) Foreign Application Priority Data
Jan. 26, 2022 (GB) 2200999.7

(51) Int. Cl. F02M 61/16; F02M 21/02; F16K 25/00; F16K 31/06

(52) U.S. Cl. CPC F02M 61/166; F02M 21/0206; F02M 21/026; F02M 21/0272; F02M 2200/02; F02M 2200/9061; F16K 25/005; F16K 31/0665

(57) ABSTRACT

There is provided a valve assembly comprising a valve housing. The valve housing comprises a fluid inlet, a fluid outlet, a valve opening, and a valve seat surrounding the valve opening, The valve opening is disposed between the fluid inlet and the fluid outlet. The valve assembly further comprises a ball valve element disposed within the valve housing, a spring arranged to urge the ball valve element onto the valve seat to close the valve opening, and a drive pin having a first end and a second end, the drive pin being aligned with the valve opening. The valve assembly is movable between a closed position, in which the ball valve element is held in the valve seat by the spring, closing the valve opening, and an open position, in which the first end of the drive pin extends through the valve opening to push the ball valve element away from the valve seat, opening the valve opening. At least one of the spring, ball valve element, valve seat, and first end of the drive pin includes a hard surface treatment. There is also provided a fluid injection system for injecting a fluid comprising a source of a fluid and a valve assembly, the source of a fluid being connected to the fluid inlet of the valve assembly.

### CROSS-REFERENCE TO RELATED APPLICATIONS

This application is the U.S. national phase of PCT/GB2023/050165, filed on Jan. 26, 2023, which claims the benefit of United Kingdom Patent Application Number 2200999.7, filed on Jan. 26, 2023, the entire disclosures of both of which are hereby incorporated by reference herein.

### FIELD OF THE DISCLOSURE

The present disclosure relates to a valve assembly. In particular, the present disclosure relates to a valve assembly in which at least one component includes a hard surface treatment. The present disclosure also relates to a fluid injection system for injecting a fluid.

### BACKGROUND

Injectors, sometimes known as injection valves, are used to control the flow of fluids, such as fuels, in various applications. For example, fuel injectors are used in internal combustion engines to control the delivery of fuel to various portions of the engine. Known fuel injectors typically comprise a body having an opening, the opening being closable by a valve. Known fuel injectors include several adjacent sliding surfaces with tight tolerances to provide a good seal. For example, needle valves include a needle, the movement of which within the valve opens and closes one or more nozzle holes to control the flow of fuel. Fuel injectors typically open and close several times a second during use. This can make the fuel injectors susceptible to failure due to wear and seizure.

Known fuel injectors are typically used with a petroleum based fuel, such as petrol or diesel, which act to lubricate the moving parts of the fuel injector. This may mitigate the risk of failure of the fuel injector due to wear and seizure. Additional lubricants, such as oil, may be added to the fuel or to the fuel injector to further improve the failure resistance of the fuel injector, and other components of the engine.

However, the use of petroleum based fuels in internal combustion engines leads to the undesirable generation of greenhouse gas emissions. Furthermore, the addition of lubricants to improve the wear resistance of the fuel injector may also lead to the undesirable generation of greenhouse gas emissions.

Alternative fuels have been contemplated. For example, hydrogen has been contemplated as an alternative to petroleum based fuels since it advantageously does not produce greenhouse emissions when combusted, producing only water. In addition, ammonia has been proposed as an alternative to petroleum based fuels since it advantageously does not produce greenhouse emissions when combusted, producing only nitrogen and water. Other fluids are contemplated and are discussed in more detail below.

However, both hydrogen and ammonia are dry gasses and do not provide the lubricating benefits of petroleum based fuels. The use of hydrogen and ammonia in traditional fuel injectors may result in increased wear and seizure failure. In particular, it has been found that the wear rate when using a fuel injector with hydrogen is considerably higher than when the same fuel injector used with a petroleum based fuel. This has the effect of reducing the life of the fuel injector. While additional lubricant could be added, this may undermine the environmental credentials of alternative fuels such as hydrogen and ammonia fuels. In addition, certain materials used in known valves may not be compatible for use with alternative fluids such as hydrogen or ammonia. For example, steel valve components may be susceptible to hydrogen embrittlement, shortening the life of the fuel injector. Certain polymeric components of known valves, such as bushes and coil overmouldings, can also become degraded by certain alternative fluids. In addition, it has been found that ammonia when used in known fuel injectors may lead to corrosion of certain steel components. In addition, where known fuel injectors are used to control the flow of alcohols, such as methanol and ethanol, residue has been found to accumulate on various surfaces. Where this residue accumulates on adjacent sliding surfaces where there are very tight tolerances, the residue can lead to the seizure of the valve.

Accordingly, there is a need to provide a fluid injector which has an increased lifespan and resistance to failure when used with a dry fluid, such as hydrogen and ammonia. It would further be desirable to provide such a fuel injector which does not require additional lubricant to mitigate failure.

### SUMMARY

According to a first aspect of the present disclosure, there is provided a valve assembly comprising: a valve housing comprising a fluid inlet, a fluid outlet, a valve opening, and a valve seat surrounding the valve opening, the valve opening being disposed between the fluid inlet and the fluid outlet, a ball valve element disposed within the valve housing, a spring arranged to urge the ball valve element onto the valve seat to close the valve opening, and a drive pin having a first end and a second end, the drive pin being aligned with the valve opening, the valve assembly being movable between a closed position, in which the ball valve element is held in the valve seat by the spring, closing the valve opening, and an open position, in which the first end of the drive pin extends through the valve opening to push the ball valve element away from the valve seat, opening the valve opening, wherein at least one of the spring, ball valve element, valve seat, and first end of the drive pin includes a hard surface treatment.

The inventors have identified that the provision of a valve assembly in which the opening and closing of the valve is controlled by the movement of a ball valve element may advantageously reduce wear experienced by the components of the valve assembly. This may be because the operation of the valve assembly according to the disclosure does not require the movement of several adjacent sliding surfaces with very tight tolerances. For this reason, lubrication by petroleum based fuels or otherwise, is also not necessary to extend the life of the valve assembly of the present disclosure. In particular, while the valve assembly of the present disclosure may include sliding surfaces, these sliding surfaces are not essential to provide sealing. Instead, the valve assembly is sealed by the ball valve element being in the valve seat. The ball valve element may advantageously maximise the seating area whilst supporting the seat edge material. The provision of a ball valve element is further advantageous since the reliability of the valve to form a seal is not dependant on the tolerances of other components. In addition, the use of a ball valve element removes the need for precisely engineered straight component or components with precise angles, which may be particularly susceptible to hydrogen embrittlement where the valve element is used to control the flow of hydrogen. In addition, the inventors have surprisingly found that the wear experienced by a ball valve element is generally uniform and the effectiveness of the seal can advantageously improve during the use of the valve assembly as the ball valve element is worn to the shape of the valve seat.

Accordingly, it has advantageously been found that the valve assembly with the structure according to the present disclosure is particularly suitable for use with dry, or liquid free, fluids such as hydrogen or ammonia without the need for additional lubricants.

Furthermore, the inventors have identified that certain components of the valve assembly may be particularly susceptible to wear, particularly when the valve assembly is used with a dry gas. To extend the life of the valve assembly further, at least one of the spring, ball valve element, valve seat, and first end of the drive pin includes a hard surface treatment. The spring, ball valve element, valve seat, and first end of the drive pin may collectively be referred to as ‘components’.

As used herein with reference to the present disclosure, the term ‘hard surface treatment’ refers to any process which increases the hardness of at least a portion of the surface of the component compared to the hardness before the process. The hard surface treatment may be applied to the component before the final construction of the valve assembly. More than one of the components may include a hard surface treatment. Where this is the case, the components may have the same surface treatment.

Alternatively, the components may have a different surface treatment. Where the components have different surface treatments, the surface hardness of the components may vary between components. At least one of the spring, ball valve element, valve seat, and first end of the drive pin may include a first hard surface treatment. At least one of the spring, ball valve element, valve seat, and first end of the drive pin, which does not include the first hard surface treatment, may include a second hard surface treatment. The first hard surface treatment may harden the treated component to a greater extent than the second hard surface treatment hardens the treated component.

For example, the ball valve element may include a first hard surface treatment and the valve seat may include a second hard surface treatment. The first hard surface treatment may harden the ball valve element to a greater extent than the second hard surface treatment. The resulting hardness of the ball valve element may be higher than the hardness of the valve seat.

At least one of the spring, ball valve element, valve sear, and first end of the drive pin may include a non-hardening surface treatment. The component including a non-hardening surface treatment may be the same component which includes the hard surface treatment. The component including a non-hardening surface treatment may not be the same component which includes the hard surface treatment.

Non-hardening surface treatments may be referred to as complimentary surface treatments. Examples of suitable non-hardening surface treatments include the application of lubrication, or a surface finishing technique. Suitable lubricants include, but are not limited to, grease and bedding in fluid. Suitable surface finishing techniques include, but are not limited to, lapping, super finishing, and polishing.

For example, the ball valve element may include a hard surface treatment, and the valve seat may include a non-hardening surface treatment. In a further example, the ball valve element may include a first hard surface treatment, and the valve seat may include a second hard surface treatment and a non-hardening surface treatment; the first hard surface treatment may harden the ball valve element to a greater extent than the second hard surface treatment hardens the valve seat.

As described in more detail below, the hard surface treatment may be any hard surface treatment. For example, the hard surface treatment may comprise a hard coating applied to the surface of the one or more components. Alternatively, or in addition, the hard surface treatment may include a physical process such as a heat treatment process or a cold working process.

As used herein with reference to the present disclosure, the term ‘fluid’ refers to both liquid and gas. As described in more detail below, the valve assembly of the present disclosure may be used for controlling the flow of both liquid or gas, in particular liquid or gas fuel.

In use, the fluid inlet may be connected to a source of fluid. In the closed position, the spring urges the ball valve element against the valve seat to close the valve opening. This prevents fluid from passing from the fluid inlet to the fluid outlet. When the valve assembly is activated, the drive pin moves towards the ball valve element, and the first end of the drive pin pushes the ball valve element away from the valve seat, against the action of the spring. This removes the seal from the valve opening to allow fluid to pass from the fluid inlet to the fluid outlet.

The valve assembly of the present disclosure may find application in any situation where controlled delivery of a fluid (a gas or a liquid) is required. As described above, the valve assembly of the present disclosure may be particularly suitable for use with aggressive fluids which do not provide lubrication to the valve assembly components.

The valve assembly of the present disclosure may be suitable for the controlled delivery of fuels. The valve assembly of the present disclosure may be used for the delivery of fuel in an internal combustion engine or a fuel cell. For example, the valve assembly of the present disclosure may be suitable for the controlled delivery of hydrogen, ammonia, compressed natural gas (CNG), liquified natural gas (LNG), biomethane, alcohol (such as ethanol or methanol), gasoline, kerosene, diesel, or avgas.

The valve assembly of the present disclosure may be suitable for the controlled delivery of other fluids which are not fuels. For example, the valve assembly of the present disclosure may be suitable for the controlled delivery of engine oil, hydraulic fluid, grease, or gasses such as nitrogen.

The valve assembly may have a longitudinal axis. The spring, the valve opening, ball valve element, and drive pin may be aligned along the longitudinal axis such that the opening and closing of the valve assembly coincides with the movement of the drive pin and ball valve element along the longitudinal axis of the valve assembly. Similarly, the opening and closing of the valve assembly may coincide with the extension and compression of the spring along the longitudinal axis of the valve assembly.

The valve assembly may further comprise a spring seat, the ball valve element being disposed between the valve seat and the spring seat such that, when the valve is in the open position, the ball valve element is in contact with the spring seat.

The spring seat may advantageously limit the movement of the ball valve element away from the valve seat to limit the extent to which the valve opening is open. The provision of the spring seat may also advantageously remove the need for careful control of the movement of the drive pin since the movement of the ball valve element is limited by the spring seat. The provision of the spring seat may also advantageously prevent or reduce damage to the spring caused by over compression during opening of the valve assembly.

The spring seat may comprise a pin extending from the inner surface of the valve housing towards the valve opening and aligned with the longitudinal axis of the valve assembly. The spring seat may pass through the centre of the spring. Where this is the case, the spring seat may advantageously act to keep the spring in position and guide the movement of the spring during use of the valve assembly.

The spring seat may include a hard surface treatment.

As with the spring, ball valve element, valve seat, and first end of the drive pin, the inventors have identified that the spring seat may be subject to wear during the use of the valve assembly since it comes into direct contact with the ball valve element. Accordingly, the provision of a hard surface treatment may reduce wear on the spring seat and advantageously extend the life of the valve assembly before failure. As described above, this is particularly relevant where the valve assembly is used with a dry gas with little or no lubricating properties.

The valve assembly may further comprise a pole piece, the drive pin extending through a bore in the pole piece.

The pole piece may be disposed within the valve housing. The bore of the pole piece may be aligned with the longitudinal axis of the valve assembly. Advantageously, the pole piece is provided to support and guide the movement of the drive pin as it moves along the longitudinal direction during the opening and closing of the valve assembly.

The pole piece may include a hard surface treatment.

As with the spring, ball valve element, valve seat, and first end of the drive pin, the inventors have identified that the pole piece may be subject to wear during the use of the valve assembly since it comes into direct contact with the drive pin. In particular, the inner surface of the bore in the pole piece may include a hard surface treatment. Accordingly, the provision of a hard surface treatment may reduce wear on the pole piece and advantageously extend the life of the valve assembly before failure. As described above, this is particularly relevant where the valve assembly is used with a dry gas with little or no lubricating properties.

Where the valve assembly comprises a pole piece, the entire length of the drive pin, in addition to the first end, may include a hard surface treatment. This may advantageously prevent or reduce wear caused by friction between the drive pin and the bore in the pole piece.

In addition to the components described above, the spring seat and the pole piece may be collectively referred to as ‘components’.

Alternatively or in addition, the pole piece may include a non-hardening surface treatment. The non-hardening surface treatment may be any non-hardening surface treatment as described above.

Each of the spring, ball valve element, valve seat, first end of the drive pin, spring seat, and pole piece may include a hard surface treatment. The provision of a hard surface treatment on all of these components may advantageously maximise the wear resistance of the valve assembly.

The hard surface treatment, or the first and second hard surface treatments, may be any hard surface treatment.

The hard surface treatment, or the first and second hard surface treatments, may comprise a hard coating applied to the surface of the one or more components. The hard coating may comprise a hard material applied to the surface of the component. For example, the hard coating may comprise a material having a Vickers hardness of greater than 500 HV. For example, the hard coating may comprise a material having a Vickers hardness of greater than 750 HV, or greater than 1000 HV.

The surface of one or more components may be coated using any suitable coating technique. For example, the coating of hard material may be applied by sputtering, physical vapour deposition, or dip coating.

The hard coating may comprise at least one of an oxide, a nitride, a carbide, a boride, and an oxide. For example, the hard coating may comprise silicon nitride. The hard coating may comprise a carbon based material. For example, the hard coating may comprise diamond-like carbon (DLC).

It has been found that these materials are particularly suitable for hardening the surface of one or more of the components of the valve assembly of the present disclosure.

The hard surface treatment may include a physical process.

The physical process may be any process applied to the surface of the component to increase the hardness of the surface of the component without the addition of hard materials.

The hard surface treatment may include a cold working process. For example the physical process may include one or more of shot peening, cold rolling, or cold drawing.

The hard surface treatment may include a heat treatment. For example, the physical process may include quench hardening, solid solution strengthening, or precipitation hardening.

The ball valve element may be formed from silicon nitride.

The inventors have found that the ball valve element may be particularly susceptible to wear during use of the valve assembly since the ball valve element comes into contact with both the valve seat and the spring seat at different points during the opening and closing of the valve assembly. Accordingly, manufacturing the entire ball valve element from silicon nitride may further improve the wear resistance of the valve assembly and reduce the likelihood of failure.

The valve assembly may be a solenoid valve assembly.

The valve assembly may further comprise an armature connected to the second end of the drive pin, and a coil surrounding the armature such that energisation of the coil causes the drive pin to move, actuating the valve between the closed position to the open position.

The provision of an armature and a coil may provide a convenient way for the valve assembly to be opened and closed. The armature may be aligned with the longitudinal axis of the valve assembly. The armature may comprise a magnetic material. For example, the armature may comprise a ferromagnetic material.

The valve assembly may further comprise a first guide bushing fixedly secured to the inner surface of the valve housing, and being slidably engaged with at least a portion of the armature to guide the motion of the armature.

The provision of a first guide bushing may advantageously guide the armature as it moves between the open position of the valve assembly and the closed position of the valve assembly. This may advantageously prevent misalignment of the armature or the drive pin during use. The first guide bushing may be aligned with the longitudinal axis of the valve assembly.

The armature may be stepped and may have a rear end portion of reduced diameter which may be surrounded and guided by the first guide bushing and a front end portion of enlarged diameter which may be located between the first guide bushing and the pole piece.

The provision of the stepped rear end portion of the armature may advantageously provide a space for the first guide bushing without the need to machine a space for it on the inner surface of the valve housing.

The first guide bushing may be formed from any material. The first guide bushing may comprise a metallic material. For example, the first bushing may comprise at least one of sintered bronze, copper, or brass. The first guide bushing may comprise a non-metallic material. For example, the first guide bushing may comprise a polymeric material. The first guide bushing may comprise polytetrafluoroethylene (PTFE).

The inventors have identified that where the valve assembly is used to control the delivery of ammonia, the ammonia may cause the corrosion of certain metallic bushings, particularly bushings containing copper. The inventors have identified PTFE as a suitable material for the first guide bushing where the valve assembly is used with ammonia.

The valve assembly may further comprise a second guide bushing. The second guide bushing may be fixedly secured to the inner surface of the valve housing and be slidably engaged with at least a portion of the drive pin to guide the motion of the drive pin.

The provision of a second guide bushing may advantageously guide the drive pin as it moves between the open position of the valve assembly and the closed position of the valve assembly. This may advantageously prevent misalignment of the drive pin during use. The second guide bushing may be aligned with the longitudinal axis of the valve assembly.

The valve assembly may be configured to control the flow of a relatively liquid free gas therethrough. As described above, the valve of the present disclosure is particularly suited for use with liquid free, or dry, gas since the lack of tight sliding elements reduces wear on the valve assembly, despite the absence lubrication. In addition, the hard surface treatment applied to components particularly susceptible to wear may further improve the wear and seizure resistance of the valve assembly despite the absence of lubrication.

The valve assembly may be configured to control the flow of hydrogen gas therethrough.

The valve assembly may be configured to control the flow of ammonia gas therethrough.

According to a second aspect of the present disclosure, there is provided a fluid injection system for injecting a fluid, the system comprising: a source of a fluid and a valve assembly according to the first aspect of the present disclosure, the source of a fluid being connected to the fluid inlet of the valve assembly.

The source of a fluid may be a pressurised source of a fluid.

The source of a fluid may comprise a source of a fuel. For example, the source of a fluid may comprise a source of at least one of hydrogen, ammonia, compressed natural gas (CNG), liquified natural gas (LNG), biomethane, alcohol (such as ethanol or methanol), gasoline, kerosene, diesel, or avgas.

The source of a fluid may comprise a source of a fluid which is not a fuel. For example, the source of a fluid may comprise a source of at least one of engine oil, hydraulic fluid, grease, or gasses such as nitrogen.

The source of a fluid may comprise a source of a relatively liquid free gas.

The source of a fluid may comprise a hydrogen source.

The source of a fluid may comprise an ammonia source.

It should be appreciated that any feature in one aspect of the disclosure may be applied to other aspects of the disclosure, in any appropriate combination. Furthermore, any, some and/or all features in one aspect can be applied to any, some and/or all features in any other aspect, in any appropriate combination.

It should also be appreciated that particular combinations of the various features described and defined in any aspects of the disclosure can be implemented and/or supplied and/or used independently.

### BRIEF DESCRIPTION OF THE DRAWINGS

The invention is defined in the claims. However, a non-limiting example will now be further described with reference to the figures in which:

FIG. 1 is a cross sectional view of a valve element in accordance with the present disclosure in the closed position;

FIG. 2 is a cross sectional view of a valve element in accordance with the present disclosure in the open position.

### DETAILED DESCRIPTION

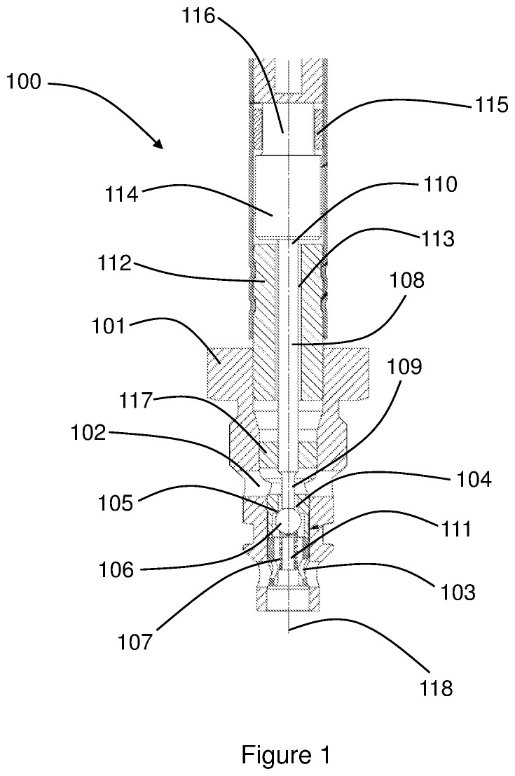

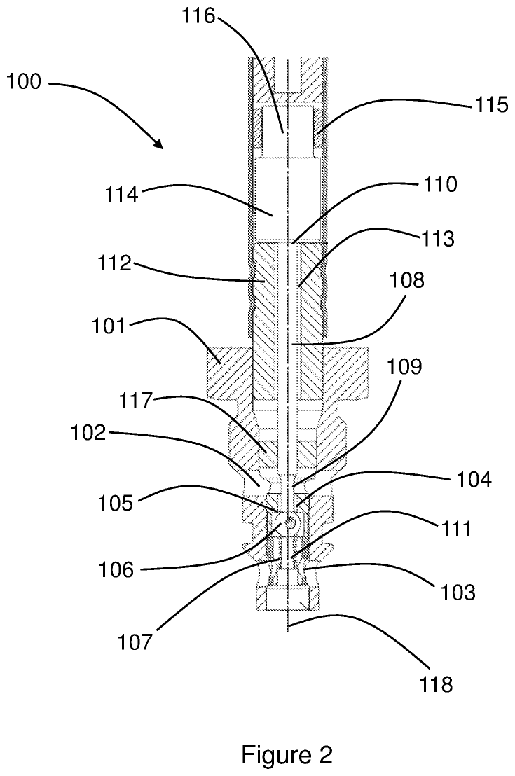

FIG. 1 and FIG. 2 show an example valve element 100 in accordance with the present disclosure. The valve element 100 comprises a valve housing 101. The valve housing 101 includes a fluid inlet 102 through which fluid may enter the valve element 100, and a fluid outlet 103 through which fluid may exit the valve element 100. The valve housing 101 further includes a valve opening 104 disposed between the fluid inlet 102 and the fluid outlet 103. The valve opening 104 is in the form of a circular opening. A valve seat 105 is provided about the circumference of the valve opening 104.

The valve assembly 100 further comprises a ball valve element 106 disposed within the valve housing 101. The ball valve element 106 comprises a sphere of silicon nitride. The diameter of the ball valve element 106 is larger than the diameter of the valve opening 104.

The valve assembly 100 further comprises a spring 107 disposed adjacent the ball valve element 106, the spring 107 being arranged to urge the ball valve element 106 onto the valve seat 105 to close the valve opening 104. The spring 107 is a compression spring.

The valve assembly 100 further comprises a drive pin 108, the drive pin 108 being in the form of an elongate rod having a first end 109 and a second end 110. The diameter of the first end 109 of the drive pin 108 is less than the diameter of the valve opening 104 such that the first end 109 of the drive pin 108 can pass through the valve opening 104.

The valve assembly 100 further includes a spring seat 111. The ball valve element 106 is disposed between the valve seat 105 and the spring seat 111. The spring seat 111 comprises a pin extending from the valve housing 101 towards the valve opening 104. The diameter of the spring seat 111 is less than the diameter of the spring 107 such that the spring seat 111 passes through the spring 107.

The distance between the valve seat 105 and the spring seat 111 is greater than the diameter of the ball valve element 106 such that the ball valve element is able to move between the valve seat 105 and the spring seat 111.

The valve assembly 100 further comprises a pole piece 112. The pole piece 112 comprises a cylindrical bore 113. The diameter of the cylindrical bore 113 is larger than the diameter of the drive pin 108 such that the drive pin 108 is able to move longitudinally through the pole piece 112.

Each of the spring 107, the ball valve element 106, the valve seat 105, the first end of the drive pin 109, the spring seat 111, and the pole piece 112 includes a hard surface treatment. In this embodiment of the disclosure, the hard surface treatment comprises a coating of diamond-like carbon applied using a physical vapor deposition process.

The valve assembly 100 further comprises an armature 114 disposed at, and attached to, the second end 110 of the drive pin 108. The valve assembly 100 further comprises a coil (not shown) surrounding the armature 114. The armature 114 is formed from a ferromagnetic material. The armature 114 includes a rear potion 116 having a reduced diameter compared to the rest of the armature 114. The valve assembly 100 further comprises a first guide bushing 115 disposed within, and fixedly secured to, the valve housing 101. The first guide bushing 115 includes an opening, the diameter of the opening is larger than the diameter of the rear portion 116 of the armature 114 such that the first guide bushing 115 is disposed about the rear portion 116 of the armature 114.

The valve assembly 100 further comprises a second guide bushing 117 disposed within, and fixedly secured to, the valve housing 101. The second guide bushing 117 is located near the first end 109 of the drive pin 108. The second guide bushing 117 includes an opening, the diameter of the opening is larger than the diameter of the drive pin 108 such that the second guide bushing 117 is disposed about the drive pin.

The valve assembly 100 includes a longitudinal axis 118. The first guide bushing 115, the armature 114, the drive pin 109, the pole piece 112, the second guide bushing 117, the valve opening 104, the ball valve element 106, the spring seat 111, and the spring 107 are all aligned along the longitudinal axis 118 of the valve assembly 100.

The valve assembly 100 may be used as part of a gaseous injection system for injecting gas. Where this is the case, a source of a fluid is connected to the fluid inlet 102 of the valve assembly 100. The source of a fluid is a pressurised source of hydrogen.

In use, the valve assembly 100 may be in the closed position as shown in FIG. 1. In the closed position, the coils (not shown) are not energised. The spring 107 urges the ball valve element 106 onto the valve seat 105 to close the valve opening 104. The ball valve element 106 forms a seal around the valve seat 105 to prevent the fluid from passing from the fluid inlet 102 to the fluid outlet 103.

When the coils are energised, as shown in FIG. 2, the armature 114 is urged towards the valve opening 104. The armature 114 is guided by the first guide bushing 115. This auction also moves the drive pin 108 towards the valve opening 104. The drive pin 108 is guided by the pole piece 112 and the second guide bushing 117. The first end 109 of the drive pin 108 passes through the valve opening 104 to push the ball valve element 106 away from the valve seat 105 and onto the spring seat 111, compressing the spring 107. This opens the valve opening 104 allowing fluid to pass from the fluid inlet 102, around the ball valve element 106, and out of the fluid outlet 103.

1. A valve assembly comprising:
a valve housing comprising a fluid inlet, a fluid outlet, a valve opening, and a valve seat surrounding the valve opening, the valve opening being disposed between the fluid inlet and the fluid outlet,
a ball valve element disposed within the valve housing,
a spring arranged to urge the ball valve element onto the valve seat to close the valve opening, and
a drive pin having a first end and a second end, the drive pin being aligned with the valve opening,
the valve assembly being movable between
a closed position, in which the ball valve element is held in the valve seat by the spring, closing the valve opening, and
an open position, in which the first end of the drive pin extends through the valve opening to push the ball valve element away from the valve seat, opening the valve opening,
wherein at least one of the spring, ball valve element, valve seat, and first end of the drive pin includes a hard surface treatment.

2. A valve assembly according to claim 1, further comprising a spring seat, the ball valve element being disposed between the valve seat and the spring seat such that, when the valve is in the open position, the ball valve element is in contact with the spring seat.

3. A valve assembly according to claim 2, wherein the spring seat includes a hard surface treatment.

4. A valve assembly according to claim 2, further comprising a pole piece, the drive pin extending through a bore in the pole piece.

5. A valve assembly according to claim 4, wherein the pole piece includes a hard surface treatment.

6. A valve assembly according to claim 4, wherein each of the spring, ball valve element, valve seat, first end of the drive pin, spring seat, and pole piece include a hard surface treatment.

7. A valve assembly according to claim 1, wherein the hard surface treatment comprises a hard coating applied to the surface of the one or more components.

8. A valve assembly according to claim 7, wherein the hard coating comprises at least one of silicon nitride, diamond-like carbon, a metal carbide or nitride.

9. A valve assembly according to claim 1, wherein the hard surface treatment includes a physical process.

10. A valve assembly according to claim 1, where the ball valve element is formed from silicon nitride.

11. A valve assembly according to claim 1, further comprising:
an armature connected to the second end of the drive pin, and
a coil surrounding the armature such that energisation of the coil causes the drive pin to move, actuating the valve between the closed position to the open position.

12. A valve assembly according to claim 11, further comprising a first guide bushing fixedly secured to the inner surface of the valve housing, and being slidably engaged with at least a portion of the armature to guide the motion of the armature.

13. A valve assembly according to claim 12, wherein the armature is stepped and has a rear end portion of reduced diameter which is surrounded and guided by the first guide bushing and a front end portion of enlarged diameter which is located between the first guide bushing and the pole piece.

14. A valve assembly according to claim 12, wherein the first guide bushing comprises polytetrafluoroethylene.

15. A valve assembly according to claim 1, wherein the valve assembly is configured to control the flow of a relatively liquid free gas therethrough.

16. A valve assembly according to claim 1, wherein the valve assembly is configured to control the flow of hydrogen gas therethrough.

17. A valve assembly according to claim 1, wherein the valve assembly is configured to control the flow of ammonia gas therethrough.

18. A fluid injection system for injecting a fluid, the system comprising:
a source of a fluid, and
a valve assembly according to any preceding claim, the source of a fluid being connected to the fluid inlet of the valve assembly.

19. A fluid injection system according to claim 18, wherein the source of a fluid comprises a source of a relatively liquid free gas.

20. A fluid injection system according to claim 18, wherein the source of a fluid comprises a hydrogen source.

21. A fluid injection system according to claim 18, wherein the source of a fluid comprises an ammonia source.
